(19) United States
(12) Patent Application Publication
(10) Pub. No.: US 2007/0299649 A1
(43) Pub. Date: Dec. 27, 2007

(54) Multi-Channel Client System

(76) Inventor: Kwok-Yan Leung, Willowdale (CA)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/425,865

(22) Filed: Jun. 22, 2006

(51) Int. Cl. G06F 9/455

(52) U.S. Cl. 703/25

(57) ABSTRACT

A multi-channel client system is provided herein, which makes it possible for a single host to receive/respond to sequence events sent from a plurality of client devices through their corresponding communication channels respectively. A socket module is executed in each client device, and a plurality of session modules each corresponding to a client device are executed in the host respectively, so that the sequence events belonging to the client devices may be received/responded to simultaneously through the channels.

### BACKGROUND OF THE INVENTION

1. Field of the Invention

The present invention relates to a client system, and in particular to a multi-channel client system.

2. The Prior Arts

With the globalization of corporations, computer network has become one of the major points of corporate information development. However, as far as the long-distance information application among corporate branches is concerned, a localized computer network faces such challenges as information security, large bandwidth requirement with low system efficiency, lack of system extensibility, and high maintenance costs at the user end. These challenges bring the centralized computer network (i.e., client system) back to the favor of corporations.

However, in a conventional client system, each client has to queue to send requests of sequence events such as information sending, information processing, printing, and drawing to the host, and wait for the host to complete the events and respond to the clients one by one. Such an operation method has to be improved to fulfill the need for higher information processing efficiency.

### SUMMARY OF THE INVENTION

A primary objective of the present invention is to provide a multi-channel client system, in which a host receives and responds to the sequence event of a client device through a communication channel established between a socket module of the client and the corresponding session module of the host to improve the system efficiency.

In this way, the multi-channel client system of the present invention enables a single host to receive/respond to the sequence event requests from a plurality of client devices through their corresponding communication channels respectively. To be more specific, a socket module is executed in each client device, and a plurality of session modules each corresponding to a client device are executed in the host respectively, so that the sequence events belonging to the client devices may be received/responded to simultaneously through the channels.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a multi-channel client system according to the present invention; and

FIG. 2 is a schematic view of a multi-channel client system according to a preferred embodiment of the present invention.

### DETAILED DESCRIPTION OF THE PREFERRED EMBODIMENT

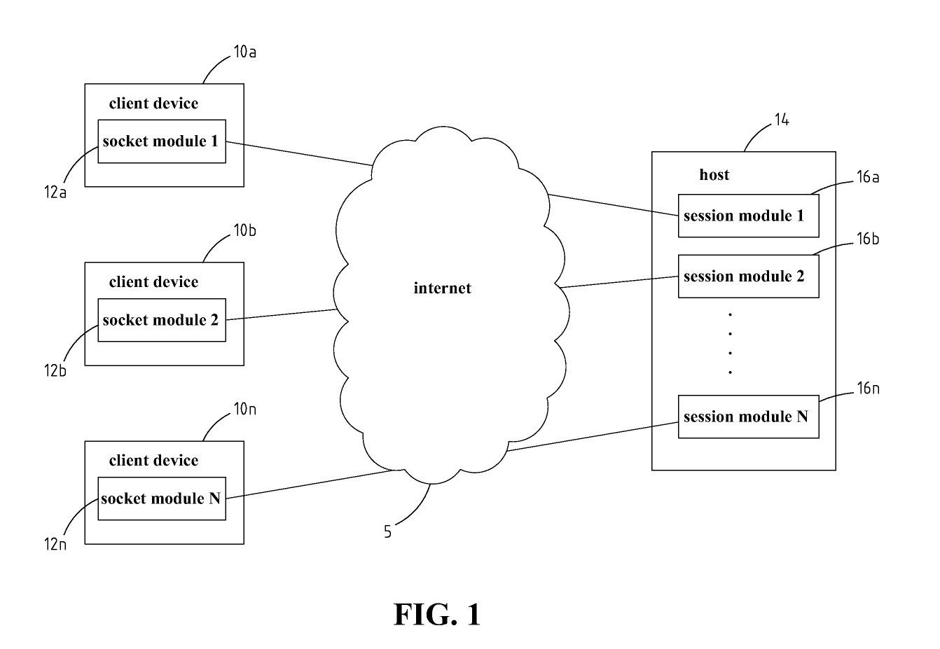

With reference to FIG. 1, a multi-channel client system in accordance with the present invention comprises mainly socket modules 1˜N 12a˜12n and session modules 1˜N 16a˜16n, which are executed in a plurality of client devices 10a˜10n and a host 14, respectively.

According to the present invention, the “multi-channel” of the multi-channel client system refers to the communication channels established between socket modules 1˜N 12a˜12n and their corresponding session modules 1˜N 16a˜16n through internet 5. In this way, a sequence event requested by the client devices 10a˜10n may be sent to the host 14 through, for example, the socket module 1 12a and its corresponding session module 1 16a without queuing, and be sent back through the same channel after it is completed by the host 14. A more detailed description will be provided below with the socket module 1 12a and the session module 1 16a as an example. Other modules may operate in the same way.

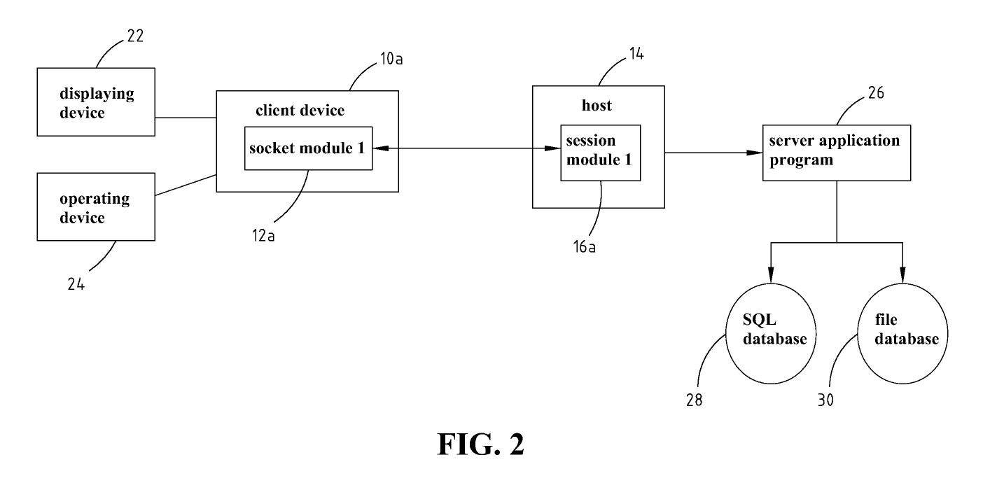

Referring to FIG. 2, with an operating device 24 and a displaying device 22, a user at the client device 10a may send a sequence event to the host 14 and receive the response from the host 14 through the communication channel established between the socket module 12a and the corresponding session module 16a.

For example, when the user tries to open a file stored in a file database 30, he/she may click on a specific folder according to the image retrieved previously from the host 14 (displayed on the displaying device 22) with the operating device 24 (such as keyboard, mouse, or other signal input devices). The sequence event of this click will be sent to the host 14 through the communication channel established between the socket module 12a and the corresponding session module 16a.

After receiving the sequence event, the host 14 may complete the requested task with a server application program 26 and respond to the sequence event through the same communication channel established between the socket module 12a and the session module 16a. That is, after the requested folder content is retrieved from file database 30 by the server application program 26, it is sent to the client device 10a. In this way, the user receives a response to the sequence event by the host 14, which is displayed on the displaying device 22. Also, a SQL database 28 may provide SQL information search similar to that mentioned above.

In addition, the security of the communication channel established between the socket module 12a and the session module 16a may be enhanced by means of encryption and decryption, and the bandwidth required for transmission may be lowered by means of compression and decompression.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multi-channel client system for a host to communicate with a plurality of client devices through internet, comprising
a plurality of socket modules, which are executed respectively in said client devices, and thereby a sequence event belonging to said corresponding client devices is capable of being sent to said host; and
a plurality of session modules, which are executed in said host to receive/respond to said sequence event with said socket module corresponding to said plurality of client devices.

2. The multi-channel client system as claimed in claim 1, wherein a user at one of said plurality of client devices is capable of sending said sequence event with an operating device to said host through a communication channel established between corresponding said socket module and said session module.

3. The multi-channel client system as claimed in claim 2, wherein said operating device is a keyboard, a mouse, or a signal input device.

4. The multi-channel client system as claimed in claim 1, wherein a user at one of said plurality of client devices is capable of receiving a response of said sequence event on a displaying device by said host through a communication channel established between corresponding said socket module and said session module.
